(19) United States
(12) Patent Application Publication
(10) Pub. No.: US 2024/0391447 A1
(43) Pub. Date: Nov. 28, 2024

(54) METHOD AND DEVICE FOR DETERMINING BRAKING-BEHAVIOR-RELEVANT PARAMETERS

(71) Applicant: Siemens Mobility GmbH, München (DE)

(72) Inventors: Steffen Jennek, Neuried (DE); Werner Breuer, München (DE); Minyi Yu, Maisach (DE); Alexander Meierhofer, Graz (AT); Klaus Six, Stainztal (AT); Gerald Trummer, Mortantsch (AT)

(21) Appl. No.: 18/694,051

(22) PCT Filed: Aug. 30, 2022
(86) PCT No.: PCT/EP2022/074009

§ 371 Date: Mar. 21, 2024

(30) Foreign Application Priority Data
Sep. 21, 2021 (DE) 10 2021 210 465.7

(51) Int. Cl. B60T 17/22; B60T 8/17; B60T 8/172

(52) U.S. Cl. CPC B60T 17/228; B60T 8/1705; B60T 8/172

(57) ABSTRACT

A method for determining at least one braking-behavior-relevant parameter relevant to the open-loop or closed-loop control of a braking system (210) of a rail vehicle (200). A physical model (PHYSM) is used in determining the at least one braking-behavior-relevant parameter, the physical model taking into account the influence of a wheel (10) which leads a wheel (20) to be braked (20), specifically with respect to an influence effect which the leading wheel (10) has on the traction between the trailing wheel (20) to be braked and the rail (30).

The invention relates to a method for determining at least one braking-behavior-relevant parameter for the control or regulation of a braking system of a rail vehicle.

In the field of rail vehicle technology, it is known to use hardware-in-the-loop (HiL) test benches as a dynamic test environment for vehicle software. Here the actual control technology hardware is combined with vehicle models. In order to implement realistic boundary conditions for driving/braking scenarios, braking-behavior-relevant parameters must be taken into account in the simulation as precisely as possible. For example, for simulating wheel-slide protection acceptance tests, which can also be used as approval tests, the test conditions of EN15595 should be reproduced as realistically as possible.

A method and a system for putting into service a brake system with specified approval requirements is known, for example, from European patent specification EP 3 331 736 B1. In the previously known method, a virtual control data set is checked on the basis of a virtual test operation to determine the extent to which it needs to be changed in order for the brake system to meet the specified approval requirements.

The object of the invention is to specify a very precise method for determining at least one braking-behavior-relevant parameter.

According to the invention, this object is achieved by a method having the features according to claim 1.

Advantageous embodiments of the method according to the invention are specified in the subclaims.

According to the invention it is provided that a physical model is used in the determining of the at least one braking-behavior-relevant parameter, the physical model taking into account the influence of a wheel which leads a wheel to be braked, specifically with respect to an influence effect which the leading wheel has on the adhesion between the trailing wheel to be braked and the rail.

A significant advantage of the method according to the invention can be seen in the fact that it enables braking-behavior-relevant parameters to be determined very precisely including in cases such as those in which a water/soap mixture is sprayed onto railroad tracks for test purposes in order to simulate specified test scenarios according to approval standards; this is because according to the invention a very relevant conditioning effect in such cases, which one or more leading wheels can exert on a wheel to be braked, is specifically taken into account.

On the basis of the braking-behavior-relevant parameters determined with the method according to the invention, a very realistic simulation of wheel-slide protection acceptance tests according to standard EN15595 is also advantageously possible, which in turn can achieve a significant reduction in complex and expensive real vehicle tests both for initial putting into service and for acceptance runs.

It is advantageous if the physical model takes into account the influence of liquid on a rail traveled by the wheel to be braked, namely by taking into account a quantity of liquid acting on the wheel to be braked, the quantity of liquid acting on the wheel to be braked being calculated taking into account a liquid reduction caused by the leading wheel. The liquid reduction can be brought about, for example, by friction of the leading wheel on the rail traveled on or by liquid adhering to or remaining on the rotating leading wheel.

On the basis of the physical model, a first auxiliary characteristic, which describes an adhesion as a function of slippage when the rail is dry, and a second auxiliary characteristic, which describes the adhesion as a function of slippage when the rail is wet, are preferably defined for the rail vehicle.

Taking into account the first and second auxiliary characteristic curve and a moisture value indicating the amount of liquid on the rail during braking, an adhesion characteristic curve lying between the first and second auxiliary characteristic curve is preferably determined, which represents the actual adhesion, which forms the or at least one of the braking-behavior-relevant parameters to be determined, over time.

The adhesion characteristic curve is determined in a particularly advantageous manner according to:

$$F x ( t ) = Fw ( ( t ) ) \cdot HK 1 ( Cx ( t ) ) + ( 1 - Fw ( t ) ) \cdot HK 2 ( Cx ( t ) )$$

where HK1 describes the first auxiliary characteristic curve as a function of the time t-dependent slippage Cx(t), HK2 describes the second auxiliary characteristic curve as a function of the time-dependent slippage Cx(t) and Fw describes the moisture value.

The first auxiliary characteristic curve HK1 is preferably determined according to

$$HK 1 = M 1 ( t ) \cdot [ Ka \cdot E 1 ( t , Q ( t ) ) / ( 1 + {E ( t , Q ( t ) )}^{2} ) + a tan ( Ks \cdot E 1 ( t , Q ( t ) ) ) ] / Pi$$

where Ka describes a dimensionless reduction factor in the adhesion region of the wheel/rail contact area, Ks a dimensionless reduction factor in the slippage region of the wheel/rail contact area, Q(t) the wheel contact force of the wheel to be braked on a rail, M1(t) a first auxiliary function of the first auxiliary characteristic curve and E1(t,Q(t)) a second auxiliary function of the first auxiliary characteristic.

The second auxiliary characteristic curve HK2 is preferably determined according to

$$HK 2 = M 2 ( t ) \cdot [ Ka \cdot E 2 ( t , Q ( t ) ) / ( 1 + E 2 {( t , Q ( t ) )}^{2} ) + a tan ( Ks \cdot E 2 ( t , Q ( t ) ) ) ] / Pi$$

where M2(t) describes a first auxiliary function of the second auxiliary characteristic curve and E2(t,Q(t)) describes a second auxiliary function of the second auxiliary characteristic.

The adhesion between the wheel to be braked and a railroad track to be traveled on is preferably determined as the braking-behavior-relevant parameter or at least one of the braking-behavior-relevant parameters.

As a braking-behavior-relevant parameter or at least one of the braking-behavior-relevant parameters, a control parameter for a slip controller can advantageously be determined as an alternative or in addition, which when braking the wheel to be braked regulates the braking force acting on the wheel in such a way that the actual slippage of the wheel corresponds to the target slippage determined using the adhesion characteristic. With the last-mentioned variant, it is thus possible to determine optimum control parameters for the slip controllers on the basis of the physical model within the framework of simulation runs, with which the approval conditions specified later in real operation can also be met under special test conditions, such as with rails wetted with a water-soap mixture.

The at least one braking-behavior-relevant parameter can be determined, for example, by a vehicle control device of the vehicle.

Alternatively or additionally, the at least one braking-behavior-relevant parameter can advantageously be determined by a facility, for example a computing facility, outside of the rail vehicle.

The at least one braking-behavior-relevant parameter can advantageously be used as part of a method for putting into service a braking system of the rail vehicle whose braking system is intended to meet specified approval requirements, with the fulfillment of the approval requirements being simulated taking into account the at least one determined braking-behavior-relevant parameter.

The invention also relates to a facility for determining at least one braking-behavior-relevant parameter for controlling or regulating a braking system of a rail vehicle. According to the invention, with respect to such a facility, it is provided that the facility is designed to use a physical model when determining the parameter, the physical model taking into account the influence of a wheel which leads a wheel to be braked, specifically with respect to an influence effect which the leading wheel has on the adhesion between the trailing wheel to be braked and the rail.

With regard to the advantages of the facility according to the invention and its advantageous embodiments, reference is made to the above statements in connection with the method according to the invention and its advantageous embodiments. Specifically, the facility can carry out all of the above method steps individually or in any combination.

It is advantageous if the facility is designed to determine the adhesion, which forms one of the braking-behavior-relevant parameters, in the form of an adhesion characteristic curve on the basis of a moisture value indicating the moisture on the rail to be traveled on, and to determine a control parameter for a slip controller of the rail vehicle on the basis of the determined adhesion characteristic curve as a further braking-behavior-relevant parameter, wherein the slip controller regulates the braking of the rail vehicle on the basis of this further braking-behavior-related parameter by regulating the slippage.

The invention also relates to a rail vehicle with a facility as described above.

With regard to the advantages of the rail vehicle according to the invention and its advantageous embodiments, reference is made to the above statements in connection with the method according to the invention and its advantageous embodiments. Specifically, the rail vehicle can carry out all of the above method steps individually or in any combination.

The invention is explained in more detail below using exemplary embodiments; these show, by way of example as follows:

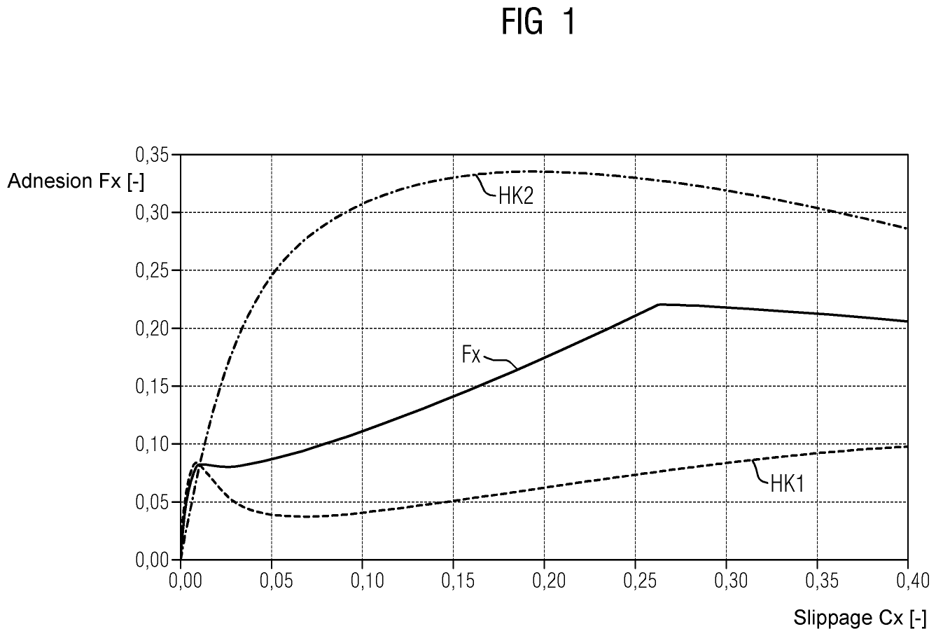

FIG. 1 auxiliary characteristic curves as a function of the slippage for different environmental conditions,

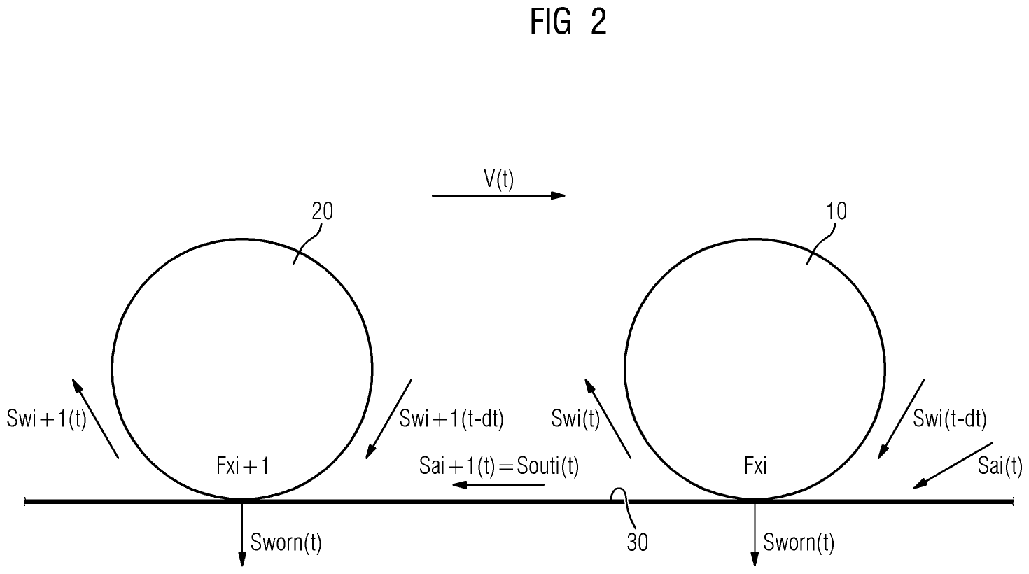

FIG. 2 a physical model describing the influence of a leading wheel on a trailing wheel to be braked,

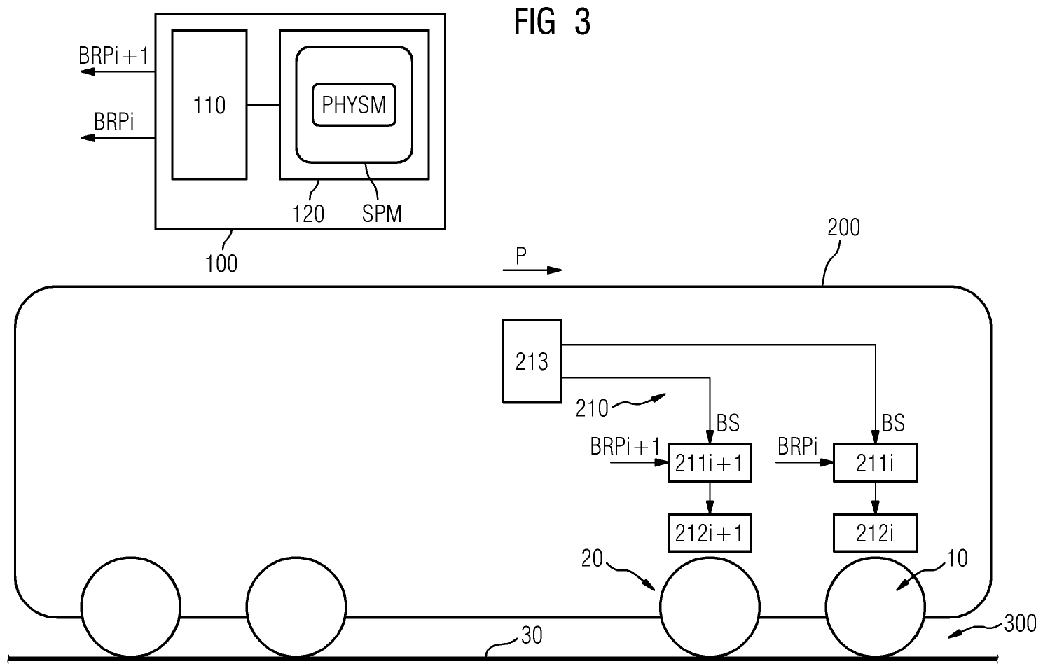

FIG. 3 an exemplary embodiment of an external facility suitable for determining at least one braking-behavior-relevant parameter for controlling or regulating at least one slip controller, and

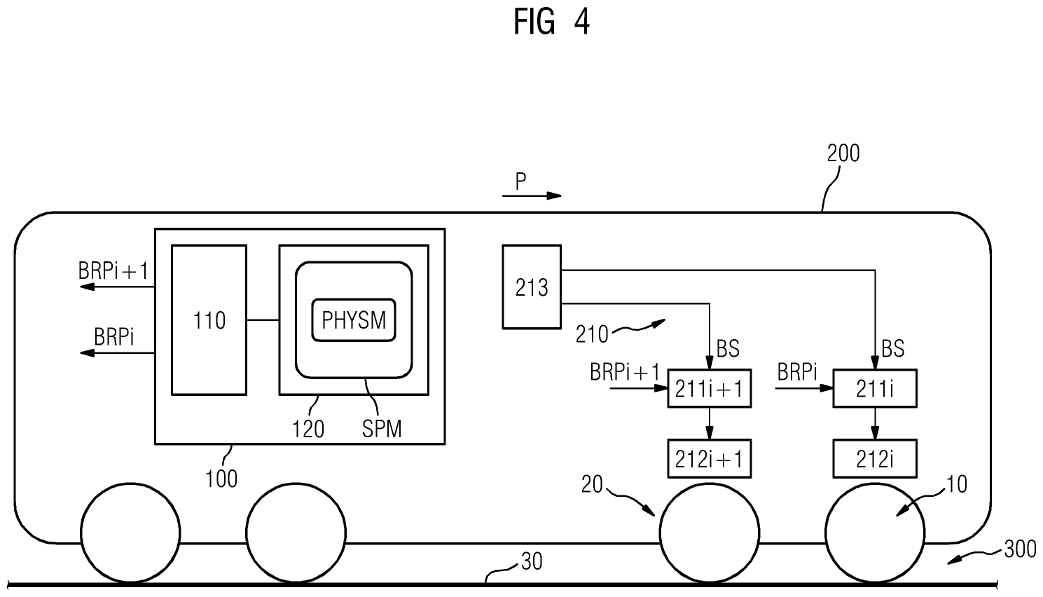

FIG. 4 an exemplary embodiment of a vehicle-internal facility suitable for determining at least one braking-behavior-relevant parameter for controlling or regulating at least one slip controller.

For the sake of clarity, the figures always use the same reference characters for identical or comparable components.

In the following, it is first explained in connection with FIGS. 1 and 2 by way of example how, on the basis of a first and second slip-dependent auxiliary characteristic curve HK1 and HK2 (see FIG. 1) and a liquid value Fw, which indicates the moisture on a rail 30 according to FIG. 2, as at least one braking-behavior-relevant parameter, the adhesion Fx for two or more wheels can be determined, with the influence of the leading wheel (see reference character 10 in FIG. 2) on the respective trailing wheel (see reference character 20 in FIG. 2) being taken into account. The adhesion Fx will fluctuate over time during a journey and thus forms an adhesion characteristic curve curve Fx(t) over time.

The two auxiliary characteristic curves HK1 and HK2 each describe the adhesion Fx as a function of the respective slippage Cx, with the first auxiliary characteristic curve HK1 describing the adhesion Fx as a function of the slippage Cx on a dry rail and the second auxiliary characteristic curve HK2 describing the adhesion Fx as a function of the slippage Cx on a wet rail.

FIG. 1 shows, by way of example, the course of the two auxiliary characteristic curves HK1 and HK2 as a function of the slippage Cx.

The adhesion characteristic curve Fx(t) of the adhesion Fx over time t is preferably calculated using the two auxiliary characteristic curves HK1 and HK2 as a function of the respective time t-dependent liquid value Fw, and the similarly time-dependent slippage Cx(t), according to

$$Fx ( t ) = Fw ( t ) \cdot HK 1 ( Cx ( t ) ) + ( 1 - Fw ( t ) ) \cdot HK 2 ( Cx ( t ) )$$

a) Calculation of the Two Auxiliary Characteristic Curves HK1 and HK2: In a first step, an auxiliary function M1(t) is determined for the first auxiliary characteristic curve HK1 and an auxiliary function M2(t) for the second auxiliary characteristic curve HK2 over time t according to

$$M 1 ( t ) = M 01 \cdot [ ( 1 - A 1 ) / exp ( - B 1 \cdot V ( t ) ) + A 1 ]$$

$$M 2 ( t ) = M 02 \cdot [ ( 1 - A 2 ) / exp ( - B 2 \cdot V ( t ) ) + A 2 ]$$

where M01 denotes the maximum of a dimensionless adhesion coefficient, which can assume a value of, for example, M01=0.08 for the first auxiliary characteristic curve HK1. M02 denotes the maximum of a dimensionless coefficient of adhesion for the second auxiliary characteristic curve HK2 and can assume a value of 0.35, for example.

A1 or A2 denotes the ratio between the minimum of the respective coefficient of adhesion and the maximum of the respective coefficient of adhesion for the respective first or second auxiliary characteristic curve HK1 and HK2. The ratio A can be of the order of 0.1 for the first auxiliary characteristic curve HK1 and of the order of 0.2 for the second auxiliary characteristic curve HK2.

B1 and B2 each designate a dimensionless factor of an exponential reduction in the drop in adhesion with increasing slippage values. The factor B1 can be of the order of 0.3 for the first auxiliary characteristic curve HK1 and of the order of 0.2 for the second auxiliary characteristic curve HK2.

V(t) denotes the translatory speed of the wheels 10 and 20 in the longitudinal direction of the vehicle over time t.

In a second step, a second auxiliary function E1(t,Q(t)) is determined for the first auxiliary characteristic curve HK1 and a second auxiliary function E2(t,Q(t)) is determined for the second auxiliary characteristic curve HK2 according to

$$E 1 ( t , Q ( t ) ) = PiG \cdot Ah \cdot Bh \cdot C\_ 11 \cdot Cx ( t ) / ( 4 \cdot Q ( t ) \cdot M 1 ( t ) )$$

$$E 2 ( t , Q ( t ) ) = Pi \cdot G \cdot Ah \cdot Bh \cdot C\_ 11 \cdot Cx ( t ) / ( 4 \cdot Q ( t ) \cdot M 2 ( t ) )$$

where Pi describes the mathematical constant or Archimedes' Constant, G a shear modulus of the wheel (for example in Pa), Ah and Bh the half axes of the contact ellipses of the wheel on the rail (for example in meters), C_11 the Kalker slip coefficient in the longitudinal direction, Cx the slippage of the wheel and Q the wheel contact force of the wheel on the rail (for example in Newton).

With M1(t) or M2(t) and E1(t,Q(t)) or E2(t,Q(t)), the first and second auxiliary characteristic curves HK1 and HK2 can then be calculated according to

$$HK 1 = M 1 ( t ) \cdot [ Ka \cdot E 1 ( t , Q ( t ) ) / ( 1 + E {( t , Q ( t ) )}^{2} ) + a tan ( Ks \cdot E 1 ( t , Q ( t ) ) ) ] / Pi$$

$$HK 2 = M 2 ( t ) \cdot [ Ka \cdot E 2 ( t , Q ( t ) ) / ( 1 + E 2 {( t , Q ( t ) )}^{2} ) + a tan ( Ks \cdot E 2 ( t , Q ( t ) ) ) ] / Pi$$

Here dimensionless reduction factors in the adhesion region of the wheel/rail contact area are denoted by Ka and dimensionless reduction factors in the slippage region of the wheel/rail contact area by Ks.

### b) Calculation of the Liquid Value Fw:

### (1) Leading Wheel 10 (See FIG. 2):

The liquid value Fw, which is used to link the two auxiliary curves HK1 and HK2 to form the adhesion characteristic curve Fx(t), is preferably calculated for the i-th leading wheel 10 on a rail 30 in the direction of travel according to

$$Fwi ( t ) = 1 / [ 1 + exp \{ - Kb \cdot ( Swi ( t - dt ) + Sai ( t ) ) / Smax ( t ) - 0.5 \} ]$$

Sai denotes a quantity of liquid added in front of the leading wheel 10, which for a test journey is sprayed on the rail in front of the leading wheel 30. Sa is calculated as follows:

$$Sai ( t ) = Kad \cdot 1 / ( V ( t ) \cdot Bh ) \cdot dV\_liquid / dt$$

where Kad denotes a dimensionless parameter, Bh the half axis length of the contact ellipse in the direction of travel, V(t) the translatory speed of the wheel in the longitudinal direction of the vehicle and dV_liquid/dt the liquid rate in the case of liquid addition.

Smax denotes the maximum quantity of liquid beneath the wheel 30 and is determined according to

Smax(t)=min(Kmax/V(t),K_lim)
where Kmax and K_lim denote dimensionless parameters.

Swi denotes the quantity of liquid beneath the i-th wheel 30 and is calculated according to:

Swi(t)=[min(Swi(t−dt)+Sai(t),Smax(t))−Sworn(t)]·K_distr
where Swi(t-dt) denotes the quantity of liquid that was present beneath the i-th wheel 30, at time t-dt (dt: duration of one wheel revolution) and is at least partially returned to the wheel contact surface after the next wheel revolution.

Sworn denotes the amount of liquid consumed by evaporation or the like, i.e. the amount of liquid that has been lost. K_distr denotes a dimensionless parameter.

Sworn is calculated according to:

Sworn(t)=Kworn·Wfriction(t)
where Kworn is a dimensionless parameter and Wfriction is the friction work of the wheel, for example in Nm (Newton meters).

For the i-th wheel 10, the adhesion characteristic curve Fxi(t) is thus given by:

$$Fxi ( t ) = Fwi ( t ) \cdot HK 1 ( t ) + ( 1 - Fwi ( t ) ) \cdot HK 2 ( t )$$

### (2) Trailing Wheel 20:

For the (i+1)-th wheel 20 trailing the i-th wheel 10, the liquid value Fwi+1, which is used to link the two auxiliary curves HK1 and HK2, is preferably calculated according to

$$Fwi + 1 ( t ) = 1 / [ 1 + exp \{ - Kb \cdot ( Swi + 1 ( t - dt ) + Sai + 1 ( t ) ) / Smax ( t ) - 0.5 ) \} ]$$

Swi+1(t), is calculated for the trailing wheel 20 like Swi(t), i.e. in exactly the same way as has been explained above for the i-th wheel 10.

Assuming that no additional quantity of liquid is added to the (i+1)th wheel 20 from the outside, Sai+1 results exclusively from the quantity of liquid that the i-th wheel 10 has left behind on the rail 30; so the following applies in this case

$$S a i + 1 ( t ) = Souti ( t )$$

where Souti describes the amount of liquid left behind by the i-th wheel 10 and can be calculated, for example, according to

Souti(t)=Kdistr·(Sai(t)+Srail(t))

With Srail (t)=Swi(t)·(1/Kdistr−1) the following applies:

$$Sai + 1 ( t ) = Souti ( t ) = Kdistr \cdot ( Sai ( t ) + Swi ( t ) \cdot ( 1 / Kdistr - 1 ) )$$

For further trailing wheels without external liquid supply, i.e. for the (i+2)-th wheel, etc., a corresponding calculation would result as for the (i+1)-th wheel, with the proviso that Sai is in each case given by the amount of liquid left behind by the leading wheel. For the (i+2)th wheel, for example, this would thus be given by

$$Sai + 2 ( t ) = Souti + 1 ( t )$$

The adhesion characteristic curve Fxi+1(t) for the trailing (i+1)-th wheel 20 is then calculated according to:

$$Fxi + 1 ( t ) = Fwi + 1 ( t ) \cdot HK 1 ( t ) + ( 1 - Fwi + 1 ( t ) ) \cdot HK 2 ( t )$$

In summary, the physical model for determining the adhesion described above in connection with FIGS. 1 and 2 takes into account that a leading i-th wheel 10 influences the amount of liquid acting on the trailing (i+1)-th wheel 20 because a portion of the leading i-th wheel-related quantity of liquid (cf. portion Kdistr·Swi(t) in the above formulas) remains on the leading i-th wheel and continues to rotate with it and another portion Sworn (t) is lost due to the friction work of the i-th wheel.

The physical model described above in connection with FIGS. 1 and 2 can be used, for example, by a facility 100 (see FIG. 3).

The facility 100 according to FIG. 3 comprises a computing facility 110 and a memory 120 in which a software module SPM is stored. When executed by the computing facility 110, the software program module SPM determines the mode of operation of the facility 100, or is at least involved in determining the mode of operation.

When the software module SPM is executed by the computing facility 110, the facility 100 preferably first executes a method with which, on the basis of the physical model for the wheels 10 and 20 of a rail vehicle 200 described above and denoted by the reference character PHYSM in FIG. 3, the adhesion characteristic curves Fxi(t) and Fxi+1(t) can be calculated. The adhesion characteristic curves Fxi(t) and Fxi+1(t) each describe the adhesion Fx as the primary braking-behavior-relevant parameter over time.

If the adhesion characteristic curves Fxi(t) and Fxi+1(t) are available, a journey of the rail vehicle 200 on a predetermined route 300 can be modeled over time by further simulation. On the basis of the simulation results of such simulated journeys, for example, suitable control parameters BRPi and BRPi+1 for controlling or regulating slip controllers 211i and 211i+1 of a brake system 210 of the rail vehicle 200 can be calculated inter alia as further (secondary) braking-behavior-relevant parameters.

In the exemplary embodiment according to FIG. 3, slip controllers 211i and 211i+1 are actuated by a brake control device 213 of brake system 210 by means of a brake signal BS.

When simulating the journey or journeys of the rail vehicle 200 on the route 300 and when determining the other braking-behavior-relevant parameters BRPi and BRPi+1, the physical model PHYSM, as has been described above in connection with FIGS. 1 and 2, is again used at least indirectly because of the use of the adhesion characteristic curves Fxi(t) and Fxi+1(t), since this is used to take into account the adhesion Fx between the wheels 10 and 20 and the rail 30 in the travel simulation.

Using the physical model PHYSM, for example, a journey can thus be simulated taking into account virtually added quantities of liquid, which are sprayed in front of the i-th (for example i=1) wheel 10 in the direction of travel P, for example. As part of the simulation or simulations, suitable or even optimal numerical values for the parameters BRPi and BRPi+1 can then advantageously be determined, which can be used in real (later) operation as control parameters in the slip controllers 211i and 211i+1 for the braking operation of the rail vehicle 200.

In the embodiment variant shown in FIG. 3, the facility 100 is preferably an external facility that tests whether the rail vehicle 200 would meet specified approval requirements before the initial putting into service of a real rail vehicle or at least before carrying out a real test journey of the rail vehicle 200. For this purpose, it first calculates the braking-behavior-relevant parameter(s) which it then uses as a basis to simulate test runs of the rail vehicle 200. As part of the simulations and tests, it determines, for example through mathematical trials, suitable braking-behavior-relevant control or regulation parameters for the braking system 210, for example the parameters BRPi and BRPi+1 for the slip controllers 211i and 211i+1, with which the approval requirements are met. The braking-behavior-relevant control or regulation parameters determined by the simulation are then implemented in the real rail vehicle. Following this implementation, real test runs can be carried out with the real rail vehicle.

FIG. 4 shows an alternative embodiment variant in which the facility 100 shown in FIG. 3 is an internal facility of the rail vehicle 200 and is formed, for example, by a vehicle control device of the rail vehicle 200 or is integrated into a vehicle control device not shown in detail. The internal facility 100 can simulate and define the braking-behavior-relevant parameter(s) before or during the journey, for example by also taking into account other current driving parameters such as temperature or rain. The braking-behavior-relevant parameters can again be control parameters for the slip controllers 211i or 211i+1, which act on the respectively assigned brake 2121 or 212i+1 of the rail vehicle 200 and regulate the braking force of the assigned brake.

The physical adhesion model described above in connection with FIGS. 1 and 2 advantageously makes it possible, to also model adhesion conditions of the wheels on a water/soap mixture or on a rail wetted with a water/soap mixture. As described, the conditioning effect of the leading wheels can be taken into account, which can lead to an increase in adhesion and correspondingly changed slippage values for the trailing wheels, because leading wheels change the water/soap mixture or reduce the quantity of it.

The physical model described in connection with FIGS. 1 and 2 enables, for example, the simulation of wheel-slide protection acceptance tests according to standard EN15595. This enables a significant reduction in complex and expensive vehicle tests in the course of initial putting into service or during acceptance runs.

Although the invention has been illustrated and described in more detail by preferred exemplary embodiments, this shall not limit the invention to the disclosed examples and other variations may be deduced from these by the person skilled in the art without extending beyond the scope of protection of the invention.

1-14. (canceled)

15. A method for determining at least one braking-behavior-relevant parameter for controlling a braking system of a rail vehicle, the method comprising:
using a physical model in determining the at least one braking-behavior-relevant parameter, the physical model taking into account an influence of a wheel leading a wheel to be braked, specifically with respect to an influence effect which the leading wheel has on an adhesion between a trailing wheel to be braked and a rail.

16. The method according to claim 15, wherein the at least one braking-behavior-relevant parameter is used in an open-loop control or closed-loop control of the braking system of the rail vehicle.

17. The method according to claim 15, which comprises:
with the physical model taking into account an influence of a liquid on the rail traveled by the wheel to be braked, by taking into account a quantity of the liquid impacting on the wheel to be braked; and
calculating the quantity of liquid impacting the wheel to be braked considering a liquid reduction caused by the leading wheel.

18. The method according to claim 15, which comprises:
based on the physical model, calculating for the rail vehicle a first auxiliary characteristic curve, which describes an adhesion as a function of slippage when the rail is dry, and a second auxiliary characteristic curve, which describes the adhesion as a function of the slippage when the rail is wet; and
taking into account the first and second auxiliary characteristic curves and a moisture value indicating an amount of liquid on the rail during braking; and
determining an adhesion characteristic curve over time lying between the first and second auxiliary characteristic curves which represents an actual adhesion, which represents the or at least one of the braking-behavior-relevant parameters to be determined.

19. The method according to claim 18, which comprises determining the adhesion characteristic curve Fx(t) according to
$$Fx ( t ) = F w ( t ) \cdot HK 1 ( Cx ( t ) ) + ( 1 - Fw ( t ) ) \cdot HK 2 ( C x ( t ) )$$
where HK1 describes the first auxiliary characteristic curve as a function of a time-dependent slippage Cx(t), HK2 describes the second auxiliary characteristic curve as a function of the time-dependent slippage Cx(t), and Fw represents the moisture value.

20. The method according to claim 18, which comprises determining the first auxiliary characteristic curve HK1 according to
$$HK 1 = M 1 ( t ) \cdot [ Ka \cdot E 1 ( t , Q ( t ) ) / ( 1 + E 1 {( t , Q ( t ) )}^{2} ) + a tan ( Ks \cdot E 1 ( t , Q ( t ) ) ) ] / pi$$
where Ka is a dimensionless reduction factor in an adhesion region of a contact area between a wheel and the rail, Ks is a dimensionless reduction factor in a slippage region of the contact area between the wheel and the rail, Q is a wheel contact force of the wheel to be braked on the rail, M1(t) is a first auxiliary function of the first auxiliary characteristic curve, and E1(t) is a second auxiliary function of the first auxiliary characteristic curve.

21. The method according to claim 18, which comprises determining the second auxiliary characteristic curve according to
$$HK 2 = M 2 ( t ) \cdot [ Ka \cdot E 2 ( t , Q ( t ) ) / ( 1 + E 2 {( t , Q ( t ) )}^{2} ) + a tan ( Ks \cdot E 2 ( t , Q ( t ) ) ) ] / pi$$
where Ka is a dimensionless reduction factor in an adhesion region of a contact area between a wheel and the rail, Ks a dimensionless reduction factor in a slippage region of the contact area between the wheel and the rail, Q is a wheel contact force of the wheel to be braked on the rail, M2(t) a first auxiliary function of the second auxiliary characteristic curve and E2(t) a second auxiliary function of the second auxiliary characteristic curve.

22. The method according to claim 15, which comprises determining an adhesion between the wheel to be braked and a railroad track as the at least one braking-behavior-relevant parameter or at least one of a plurality of braking-behavior-relevant parameters.

23. The method according to claim 15, which comprises determining as a braking-behavior-relevant parameter or at least one of a plurality of braking-behavior-relevant parameters, a control parameter for a slip controller; and
braking the wheel with a braking force subject to closed-loop control by the slip controller in such a way that an actual slippage of the wheel corresponds to a target slippage determined using an adhesion characteristic.

24. The method according to claim 15, which comprises determining the at least one braking-behavior-relevant parameter by a vehicle control device of the rail vehicle.

25. The method according to claim 15, which comprises:
determining the at least one braking-behavior-relevant parameter by a facility outside the rail vehicle and using the at least one braking-behavior-relevant parameter as part of a method for putting into service a braking system of the rail vehicle whose braking system is intended to meet specified approval requirements; and
simulating a fulfillment of the approval requirements taking into account the at least one braking-behavior-relevant parameter so determined.

26. A facility for determining at least one braking-behavior-relevant parameter for controlling a braking system of a rail vehicle, the facility being configured to use a physical model when determining the parameter, the physical model taking into account an influence of a leading wheel that leads a wheel to be braked in a direction of travel, with respect to an influence effect which the leading wheel as on an adhesion between the trailing wheel to be braked and the rail.

27. The facility according to claim 26, wherein the at least one braking-behavior-relevant parameter is used in an open-loop control or closed-loop control of the braking system of the rail vehicle.

28. The facility according to claim 26, wherein:
the facility is configured to determine the adhesion, which forms one of the braking-behavior-relevant parameters, in the form of an adhesion characteristic curve on a basis of a moisture value indicating a moisture on the rail to be traveled on, and to determine a control parameter for a slip controller of the rail vehicle based on the adhesion characteristic curve as a further braking-behavior-relevant parameter; and
said slip controller is configured to control a braking of the rail vehicle based on the further braking-behavior-related parameter by controlling the slippage in a closed-loop control.

29. A rail vehicle, comprising a facility for determining at least one braking-behavior-relevant parameter according to claim 26.

30. The rail vehicle according to claim 29, wherein:
said facility for determining at least one braking-behavior-relevant parameter is configured to determine the adhesion, which forms one of the braking-behavior-relevant parameters, in the form of an adhesion characteristic curve on a basis of a moisture value indicating a moisture on the rail to be traveled on, and to determine a control parameter for a slip controller of the rail vehicle based on the determined adhesion characteristic curve as a further braking-behavior-relevant parameter; and
wherein the slip controller controls the braking of the rail vehicle based on the further braking-behavior-related parameter by closed-loop control of the slippage.
